(19) United States
(12) Patent Application Publication
(10) Pub. No.: US 2006/0237275 A1
(43) Pub. Date: Oct. 26, 2006

(54) Control apparatus of lock-up clutch for vehicle

(75) Inventors: Hirofumi Fujita, Toyota-shi (JP); Hiromichi Kimura, Susono-shi (JP); Koji Oshima, Nagoya-shi (JP); Tomohiro Asami, Nisshin-shi (JP); Takahiro Kondo, Toyota-shi (JP); Shun Minaki, Toyota-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/404,845

(22) Filed: Apr. 17, 2006

(30) Foreign Application Priority Data
Apr. 20, 2005 (JP) 2005-122436

(51) Int. Cl. F16H 61/14

(52) U.S. Cl. 192/3.29; 192/3.31; 475/65

(57) ABSTRACT

The vehicle start determining unit determines a vehicle starting state based on a vehicle speed and an accelerator pedal press-down degree. When the vehicle starting state is determined, the target slip value determining unit determines a target slip rotational speed based on the actual accelerator pedal press-down degree. In receipt of a signal indicating initiation of the control upon the previous slip control, the running history storing unit stores a change of the vehicle speed over time after the relevant timing, and sets a running history flag to an on state when detecting that the vehicle speed has exceeded a prescribed threshold value. In receipt of the target slip rotational speed and the running history flag, if the running history flag is in the on state, the lock-up clutch control unit carries out the slip control according to the target slip rotational speed.

This nonprovisional application is based on Japanese Patent Application No. 2005-122436 filed with the Japan Patent Office on Apr. 20, 2005, the entire contents of which are hereby incorporated by reference.

### BACKGROUND OF THE INVENTION

1. Field of the Invention

The present invention relates to a control apparatus of a lock-up clutch for a vehicle, and more particularly to a control apparatus of a lock-up clutch for a vehicle guaranteeing durability of the lock-up clutch for a vehicle.

2. Description of the Background Art

A vehicle having a hydraulic power transmitting device equipped with a lock-up clutch on an engine output side is known (see, e.g., Japanese Patent Laying-Open Nos. 2005-003193 and 07-317894). In such a vehicle, the output torque of the engine is transmitted to an input shaft of an automatic transmission via the hydraulic power transmitting device equipped with the lock-up clutch.

In the vehicle having the hydraulic power transmitting device equipped with the lock-up clutch, various measures to improve fuel economy have conventionally been investigated. As one of such measures, a controller for slip of a lock-up clutch is proposed, wherein the lock-up clutch is slip-engaged when the vehicle enters a prescribed low-acceleration region in a low-speed region. For example, Japanese Patent Laying-Open No. 2005-003193 discloses a control apparatus of a lock-up clutch for a vehicle that improves fuel economy upon a start of the vehicle by performing slip control to place the lock-up clutch into a slipping state at the start of the vehicle.

More specifically, upon a start of a vehicle, the lock-up clutch is conventionally placed into a released state so as to increase the engine speed to thereby improve starting and accelerating capabilities. In this state, if an attempt is made to transmit torque exceeding the torque capacity of the hydraulic power transmitting device, the torque will be used only for an increase or rise of the engine speed, making it difficult to achieve desirable fuel economy.

By comparison, in the control apparatus of a lock-up clutch for a vehicle according to Japanese Patent Laying-Open No. 2005-003193, the lock-up clutch is placed to the slipping state upon a start of the vehicle, so that the torque from the engine is transmitted to the subsequent stages via the hydraulic power transmitting device and concurrently transmitted to the subsequent stages via the lock-up clutch. Thus, compared to the conventional case where the power is transmitted only via the hydraulic power transmitting device, the increase of the engine speed upon the start of the vehicle is restricted, which can ensure good fuel economy.

In the above-described control apparatus of a lock-up clutch for a vehicle, however, the slip control of the lock-up clutch is carried out immediately following the determination of the starting state of the vehicle to realize slip engagement thereof Thus, in the case where the start and stop of the vehicle is frequently repeated in a low-speed region, as in the case where the vehicle is in heavy traffic, the frequency of execution of the slip control is high. In such a case, a friction member of the lock-up clutch may be damaged by the heat load, leading to degradation of durability.

Therefore, it is desired in a control apparatus of a lock-up clutch for a vehicle that slip control is carried out in a manner guaranteeing durability of the lock-up clutch without impairing favorable fuel economy upon a start of the vehicle.

### SUMMARY OF THE INVENTION

In view of the foregoing, an object of the present invention is to provide a control apparatus of a lock-up clutch for a vehicle that guarantees durability of the lock-up clutch.

According to the present invention, a control apparatus of a lock-up clutch for a vehicle having a hydraulic power transmitting device equipped with a lock-up clutch includes: a slip control unit for executing slip control of the lock-up clutch upon a start of the vehicle; and a running history storing unit storing a running history of the vehicle in response to execution of the slip control after the timing of initiation of the slip control. The slip control unit executes or prohibits the slip control upon the start of the vehicle based on the running history of the vehicle stored.

With this configuration, compared to the conventional control apparatus of a lock-up clutch that carries out the slip control every time the vehicle is started, the slip control is executed at a minimum required frequency that can ensure both favorable fuel economy and durability of the lock-up clutch.

Preferably, the slip control unit prohibits the slip control when it is determined from the running history of the vehicle that the vehicle is running in heavy traffic.

The slip control is not performed when the vehicle is in heavy traffic even if the vehicle is repeatedly set to a starting state. This can reduce the frequency in execution of the slip control, so that durability of the lock-up clutch is guaranteed.

Preferably, the running history storing unit stores a change of a vehicle speed over time after the timing of initiation of the slip control. The slip control unit determines, upon the start of the vehicle, that the vehicle is running in heavy traffic based on the absence of a history indicating that the vehicle ran at a vehicle speed of not lower than a prescribed threshold value after the timing of initiation of the slip control in a previous time.

More specifically, the prescribed threshold value is set to exceed the vehicle speed at the time when the vehicle is running in heavy traffic.

With this configuration, it is readily possible to determine whether the vehicle is running in heavy traffic or not based on the change of the vehicle speed over time.

Preferably, the running history storing unit has a flag that is set to a first state in response to the initiation of the slip control, and changed from the first state to a second state in response to the vehicle speed exceeding the prescribed threshold value after the timing of the initiation of the slip control. The slip control unit executes the slip control in response to the flag being set at the second state, and prohibits the slip control in response to the flag being set at the first state, upon the start of the vehicle.

With this configuration, the slip control unit can readily determine whether the vehicle is running in heavy traffic or not based on the set state of the flag.

According to the present invention, the slip control is not performed when the vehicle is running in heavy traffic, even if the vehicle is repeatedly set to a starting state. This reduces the frequency in execution of the slip control. As a result, it is possible to ensure both favorable fuel economy upon a start of the vehicle and durability of the lock-up clutch.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a main part of a power transmitting device of a vehicle, which employs a lock-up clutch control apparatus according to an embodiment of the present invention.

FIG. 2 illustrates a configuration of a hydraulic control circuit for lock-up clutch control provided in a hydraulic control circuit.

FIG. 3 shows the relation between a signal pressure Plin output from a linear solenoid valve and a pressure difference ΔP of a lock-up clutch in the hydraulic control circuit in FIG. 2.

FIG. 4 is a functional block diagram illustrating a main part of a control function of an electronic control unit.

FIG. 5 is a flowchart illustrating a running history storing operation that is performed by a running history storing unit shown in FIG. 4.

FIG. 6 is a flowchart illustrating slip control of the lock-up clutch that is performed by a lock-up clutch control unit shown in FIG. 4.

FIG. 7 is a flowchart illustrating a slip control termination operation of the lock-up clutch that is executed by the lock-up clutch control unit shown in FIG. 4.

### DESCRIPTION OF THE PREFERRED EMBODIMENTS

Hereinafter, an embodiment of the present invention will be described in detail with reference to the drawings. In the drawings, the same reference characters denote the same or corresponding portions.

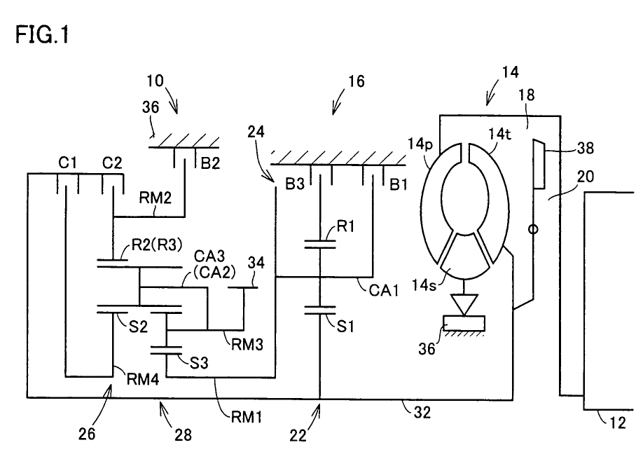

FIG. 1 shows a main part of a power transmitting device 10 of a vehicle, which employs a lock-up clutch control apparatus according to an embodiment of the present invention.

Referring to FIG. 1, the power of an engine 12 serving as a power source for running the vehicle is transmitted to left and right driving wheels, via a torque converter 14 that functions as a hydraulic power transmitting device, an automatic transmission 16, a differential gear unit (not shown), and a pair of axles.

Torque converter 14 includes a pump impeller 14p coupled to a crankshaft of engine 12, a turbine wheel 14t coupled to an input shaft 32 of automatic transmission 16 and rotated in receipt of oil from pump impeller 14p, and a stator 14s coupled to a transmission case 36 via a one-way clutch, and performs power transmission via the hydraulic fluid.

Torque converter 14 further includes a lock-up clutch 38 coupled to input shaft 32 via a damper. Lock-up clutch 38 is set to a disengaged state when the hydraulic pressure of a release-side oil chamber 20 becomes greater than that of an engage-side oil chamber 18 within torque converter 14. Thus, the torque is transmitted at an amplification factor that corresponds to an input/output rotational speed ratio of torque converter 14. When the hydraulic pressure in engage-side oil chamber 18 becomes greater than that in release-side oil chamber 20, lock-up clutch 38 is set to an engaged state. Thus, the input/output members of torque converter 14, i.e., the crankshaft and input shaft 32, are directly connected to each other. Switching of the supply state of hydraulic pressure to engage-side oil chamber 18 and release-side oil chamber 20 as well as control of the difference in pressure (pressure difference) of lock-up clutch 38 is carried out by a hydraulic control circuit, which will be described later.

Automatic transmission 16 includes single-pinion type first and second planetary gear sets 22, 26 and a double-pinion type third planetary gear set 28 that are arranged on the same axis, the input shaft 32, and an output gear 34 that rotates with a third rotary element RM3 of third planetary gear set 28. It is noted that automatic transmission 16 is configured approximately symmetrical with respect to the center line, and a lower half below the center line is not shown in FIG. 1.

First planetary gear set 22 constitutes a first transmission portion 24, and has three rotary elements of a sun gear S1, a carrier CA1 and a ring gear R1. Sun gear S1 is coupled to and rotated by input shaft 32, and ring gear R1 is fixed to transmission case 36 via a third brake B3 so as not to be rotated, so that carrier CA1 serving as an intermediate output member is rotated at a reduced speed relative to input shaft 32 to thereby output power.

Second and third planetary gear sets 26 and 28 constitute a second transmission portion 30, and has four rotary elements RM1-RM4 that are partially coupled to each other. More specifically, a sun gear S3 of third planetary gear set 28 constitutes first rotary element RM1. A ring gear R2 of second planetary gear set 26 and a ring gear R3 of third planetary gear set 28 are coupled to each other to form second rotary element RM2. A carrier CA2 of second planetary gear set 26 and a carrier CA3 of third planetary gear set 28 are coupled to each other to form third rotary element RM3, and a sun gear S2 of second planetary gear set 26 forms fourth rotary element RM4.

First rotary element RM1 (sun gear S3) is selectively coupled to transmission case 36 by a first brake B1, and stops rotating. Second rotary element RM2 (ring gears R2, R3) is selectively coupled to transmission case 36 by a second brake B2, and stops rotating. Fourth rotary element RM4 (sun gear S2) is selectively coupled to input shaft 32 via a first clutch C1, and second rotary element RM2 (ring gears R2, R3) is selectively coupled to input shaft 32 via a second clutch C2. First rotary element RM1 (sun gear S3) is integrally coupled with carrier CA1 of first planetary gear set 22 serving as the intermediate output member, and third rotary element RM3 (carriers CA2, CA3) is integrally coupled with output gear 34 so as to output rotary power.

First through third brakes B1 -B3, first clutch C1 and second clutch C2 may be formed, e.g., of a band brake having one band or two bands of opposite winding directions, or a multiple disc clutch, which are activated by hydraulic actuators. By controlling the activation of these hydraulic actuators by an electronic control unit (not shown), gear stages different in gear ratio (=rotational speed of input shaft 32/rotational speed of output gear 34) can be obtained.

Here, the hydraulic control circuit includes a hydraulic control circuit for shift control that controls the gear stages of automatic transmission 16, and a hydraulic control circuit for lock-up clutch control that controls the engagement of lock-up clutch 38. As is well known, the hydraulic control circuit for shift control is provided with first and second electromagnetic valves driven on/off by solenoids. With the combination of activation of these valves, the clutch and the brake are selectively activated to establish a desired gear stage. In the present invention, the hydraulic control circuit for lock-up clutch control has a configuration as described below for the purposes of improving fuel efficiency and guaranteeing durability of the lock-up clutch, as described above.

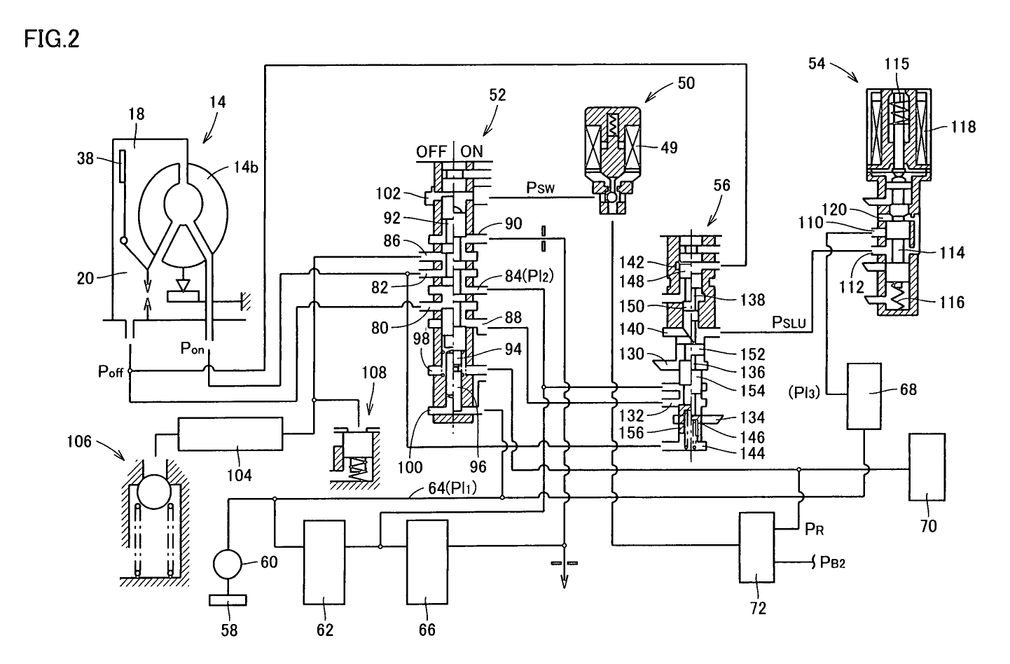

FIG. 2 shows a configuration of the hydraulic control circuit for lock-up clutch control in a hydraulic control circuit.

Referring to FIG. 2, the hydraulic control circuit for lock-up clutch control in the hydraulic control circuit 44 includes an electromagnetic switching valve 50 that is actuated on/off by a switching electromagnetic solenoid 49 to generate a switching signal pressure PSW, a clutch switching valve 52 that is switched between a release-side position for setting lock-up clutch 38 to a released state and an engagement-side position for setting lock-up clutch 38 to an engaged state in accordance with switching signal pressure PSW, a linear solenoid valve 54 that generates a slip controlling signal pressure PSLU corresponding to a drive current ISLU supplied from the electronic control unit (not shown), and a slip control valve 56 that controls the amount of slip of lock-up clutch 38 by adjusting a pressure difference ΔP between engage-side oil chamber 18 and release-side oil chamber 20, which is the engagement pressure of lock-up clutch 38, in accordance with slip controlling signal pressure PSLU output from linear solenoid valve 54.

In FIG. 2, a pump 60 is provided, which draws in the hydraulic fluid, which returned to a tank (not shown), via a strainer 58 for feeding under pressure. A relief type first regulating valve 62 regulates the pressure of the hydraulic fluid fed from pump 60 to a first line pressure Pl1. First regulating valve 62 generates first line pressure Pl1 that increases in accordance with a throttle pressure proportional to an accelerator pedal opening degree or throttle opening degree supplied from the linear solenoid valve controlled by the electronic control unit (not shown). First regulating valve 62 outputs thus generated first line pressure Pl1 via a first line oil channel 64. First line pressure Pl1 is supplied to first and second clutches C1 and C2 and first through third brakes B1 -B3 provided in automatic transmission 16.

A second regulating valve 66, which is a relief type regulating valve, regulates the pressure of the hydraulic fluid provided via first regulating valve 62 based on the throttle pressure, to generate a second line pressure Pl2 that corresponds to the output torque of engine 12.

A third regulating valve 68, which is a pressure reducing valve using first line pressure Pl1 as an original pressure, generates a constant third line pressure Pl3. A manual valve 70 generates an R range pressure PR when the shift lever is placed in the R range. An OR valve 72 selects and outputs the higher one of a pressure PB2 that actuates brake B2 and R range pressure PR.

Clutch switching valve 52 includes a release-side port 80 that communicates with release-side oil chamber 20, an engage-side port 82 that communicates with engage-side oil chamber 18, an input port 84 to which second line pressure Pl2 is supplied, a first discharge port 86 through which the hydraulic fluid in engage-side oil chamber 18 is discharged when lock-up clutch 38 is released, a second discharge port 88 through which the hydraulic fluid in release-side oil chamber 20 is discharged when lock-up clutch 38 is engaged, a supply port 90 to which a part of the hydraulic fluid discharged from second regulating valve 66 is supplied for cooling during the period when lock-up clutch 38 is engaged, a spool valve 92 that switches the connecting states of the ports, a spring 94 that urges spool valve 92 toward the off position, a plunger 96 that is arranged to be abuttable against a side end portion of spring 94 of spool valve 92, an oil chamber 98 that is provided between spool valve 92 and plunger 96 to apply R range pressure PR to the end faces of spool valve 92 and plunger 96, an oil chamber 100 that receives first line pressure Pl1 to be applied to the end face of plunger 96, and an oil chamber 102 that receives switching signal pressure PSW from electromagnetic switching valve 50 to be applied to the end face of spool valve 92 so as to generate thrust directing the same to its on position.

When electromagnetic switching valve 50 is in a non-energized state (off state), it cuts off communication between oil chamber 102 and OR valve 72 by means of a ball-like valve body, and sets oil chamber 102 at the drain pressure. In an energized state (on state), electromagnetic switching valve 50 allows communication between oil chamber 102 and OR valve 72 to cause switching signal pressure PSW to be applied to oil chamber 102. More specifically, when electromagnetic switching valve 50 is in an off state, switching signal pressure PSW from electromagnetic switching valve 50 is not applied to oil chamber 102, and spool valve 92 is set to an off position in accordance with the bias force of spring 94 and first line pressure Pl1 applied to oil chamber 100. Input port 84 and release-side port 80 communicate with each other, and engage-side port 82 and first discharge port 86 communicate with each other, and as a result, the hydraulic pressure Poff in release-side oil chamber 20 is increased to a level greater than the oil pressure Pon in engage-side oil chamber 18, and lock-up clutch 38 is released. At the same time, the hydraulic fluid in engage-side oil chamber 18 is discharged to a drain via a first discharge port 86, an oil cooler 104 and a check valve 106.

When electromagnetic switching valve 50 is in an on state, switching signal pressure PSW from electromagnetic switching valve 50 is applied to oil chamber 102, and spool valve 92 is set to an on position against the bias force of spring 94 and first line pressure Pl1 applied to oil chamber 100. Input port 84 and engage-side port 82, release-side port 80 and second discharge port 88, and supply port 90 and first discharge port 86 communicate with each other. As a result, hydraulic pressure Pon in engage-side oil chamber 18 is increased to a level greater than hydraulic pressure Poff in release-side oil chamber 20, and lock-up clutch 38 is engaged. At the same time, the hydraulic fluid in release-side oil chamber 20 is discharged to a drain via second discharge port 88 and slip control valve 56.

Linear solenoid valve 54 is a pressure reducing valve that uses the constant third line pressure Pl3 generated by third regulating valve 68 as an original pressure. Linear solenoid valve 54 generates slip controlling signal pressure PSLU that increases in accordance with drive current ISLU from the electronic control unit, and applies slip controlling signal pressure PSLU to slip control valve 56. Linear solenoid valve 54 includes a supply port 110 to which third line pressure Pl3 is supplied, an output port 112 that outputs slip controlling signal pressure PSLU, a spool valve body 114 that opens or closes the ports, a spring 115 that urges spool valve body 114 in a valve-closing direction, a slip controlling electromagnetic solenoid 118 that urges spool valve body 114 in a valve-opening direction with thrust smaller than that of spring 115, and an oil chamber 120 that receives a feedback pressure (slip controlling signal pressure PSLU) for generating and applying thrust to spool valve body 114 in the valve-closing direction. Spool valve body 114 is actuated such that the bias force in the valve-opening direction by slip controlling electromagnetic solenoid 118 and spring 116 is balanced with the bias force in the valve-closing direction by spring 115 and the feedback pressure.

Slip control valve 56 includes a line pressure port 130 to which second line pressure Pl2 is supplied, a receiving port 132 that receives the hydraulic fluid in release-side oil chamber 20 of lock-up clutch 38 that is discharged from second discharge port 88 of clutch switching valve 52, a drain port 134 for discharging the hydraulic fluid received by receiving port 132, a spool valve body 136 that is arranged to be movable between a first position (lower position in FIG. 2) for allowing communication of receiving port 132 with drain port 134 and a second position (upper position in FIG. 2) for allowing communication of receiving port 132 with line pressure port 130, a plunger 138 that is arranged to be abuttable against spool valve body 136 so as to urge spool valve body 136 toward the first position, a signal pressure oil chamber 140 that receives slip controlling signal pressure PSLU and applies slip controlling signal pressure PSLU to plunger 138 and spool valve body 136 so as to generate thrust on plunger 138 and spool valve body 136 in the directions in which plunger 138 and spool valve body 136 move away from each other, an oil chamber 142 that receives oil pressure Poff in release-side oil chamber 20 and applies oil pressure Poff to plunger 138 so as to generate thrust on plunger 138 in the direction to cause spool valve body 136 to move toward its first position, an oil chamber 144 that receives oil pressure Pon in engage-side oil chamber 18 and applies oil pressure Pon to spool valve body 136 so as to generate thrust on spool valve body 136 in the direction toward its second position, and a spring 146 that is accommodated in signal pressure oil chamber 140 and urges spool valve body 136 in the direction toward its second position.

In slip control valve 56, when spool valve body 136 is in the first position, receiving port 132 and drain port 134 communicate with each other, and the hydraulic fluid in release-side oil chamber 20 of lock-up clutch 38 is discharged. Thus, a pressure difference ΔP (=Pon−Poff) between engage-side oil chamber 18 and release-side oil chamber 20 of lock-up clutch 38 increases. When spool valve body 136 is in the second position, receiving port 132 and line pressure port 130 communicate with each other, and second line pressure Pl2 is supplied to release-side oil chamber 20 of lock-up clutch 38. Thus, pressure difference ΔP decreases.

Plunger 138 is provided with a first land 148 having a cross-sectional area A1 and a second land 150 having a cross-sectional area A2 smaller than cross-sectional area A1, with first and second lands 148 and 150 arranged in this order from the side of oil chamber 142. Spool valve body 136 is provided with a third land 152 having a cross-sectional area A3, a fourth land 154 having a cross-sectional area A4 that is smaller than cross-sectional area A3 and equal to A1, and a fifth land 156 having a cross-sectional area A5 that is equal to A1, with third, fourth and fifth lands 152, 154 and 156 arranged in this order from the side of signal pressure oil chamber 140. The cross-sectional areas of the lands satisfy the relationship of A3>A1 (=A4=A5)>A2. Thus, in the state where clutch switching valve 52 is in an on state and slip controlling signal pressure PSLU is relative small and the relationship indicated by the expression (1) below is satisfied, plunger 138 abuts against spool valve body 136 and they work in an integral manner, so that pressure difference ΔP of the magnitude corresponding to slip controlling signal pressure PSLU is generated. Pressure difference ΔP changes in a relatively moderate manner with respect to slip controlling signal pressure PSLU according to an inclination [(A3−A2)/A1] by the expression (2) below. In the expression (2), Fs represents the bias force of spring 146.
A1 o Poff≧A2 o PSLU (1)
ΔP=Pon−Poff=[(A3−A2)/A1] PSLU−Fs/A1 (2)

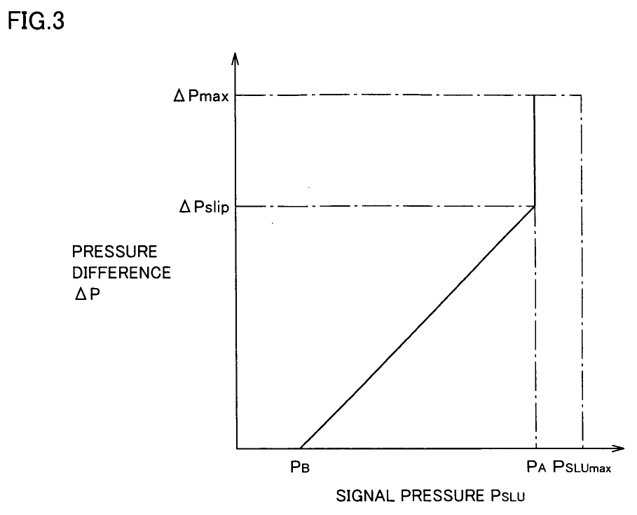

When slip controlling signal pressure PSLU becomes greater than a predetermined value PA, however, the relationship indicated by the expression (3) below is satisfied. Predetermined value PA is the value predetermined to obtain a change range ΔPslip of pressure difference ΔP of a sufficient magnitude required for the slip control of lock-up clutch 38. The cross-sectional areas and others are set such that the relationship shown by the expression (3) is satisfied when slip controlling signal pressure PSLU attains this value PA. As such, in the state where slip controlling signal pressure PSLU is greater than predetermined value PA and the relationship indicated by the expression (3) is satisfied, plunger 138 and spool valve body 136 are spaced apart from each other, and spool valve body 136 is actuated to satisfy the expression (4) below. In the state where spool valve body 136 is actuated to satisfy the expression (4), however, oil pressure Poff in release-side oil chamber 20 further decreases to reach the atmospheric pressure, since slip control valve 56 is configured to allow communication between receiving port 132 and drain port 134. Thus, pressure difference ΔP=Pon, and accordingly, the complete engagement is satisfied. The solid line in FIG. 3 indicates the characteristic in change of pressure difference ΔP obtained by actuation of slip control valve 56 with respect to slip controlling signal pressure PSLU.
A1 o Poff<A2 o PSLU (3)
A3 o PSLU=A4 o Pon+Fs (4)

Further, as shown in FIG. 3, when slip controlling signal pressure PSLU decreases to reach the value PB satisfying the expression (5) below, pressure difference ΔP=0, and thus, lock-up latch 38 attains a released state even though clutch switching valve 52 is in an on state.
A3 o Pon>A3 o PSLU (5)

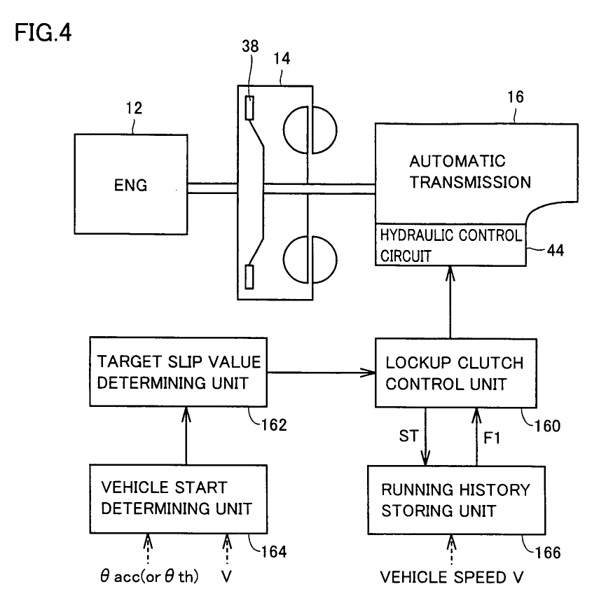

FIG. 4 is a functional block diagram illustrating a main part of the control function of the electronic control unit.

The electronic control unit includes a lock-up clutch control unit 160, a target slip value determining unit 162, a vehicle start determining unit 164, and a running history storing unit 166, in association with control of engagement of lock-up clutch 38.

Vehicle start determining unit 164 determines a starting state of the vehicle in the event that the vehicle is in a stop state (vehicle speed V=0), the brake is in a non-operated state, and the accelerator pedal press-down degree θacc or the throttle opening degree θth begins to increase from zero. Vehicle start determining unit 164 outputs the determined result to target slip value determining unit 162 and lock-up clutch control unit 160.

When the vehicle starting state is determined by vehicle start determining unit 164, target slip value determining unit 162 determines a target slip rotational speed Nsm based on the actual accelerator pedal press-down degree θacc or throttle opening degree θth, from a pre-stored relationship, so that the engine speed Ne is maintained approximately constant for an initial period of time and then gradually approaches a turbine rotational speed Nt (i.e., input shaft rotational speed Nin) that increases with vehicle speed V.

More specifically, target slip value determining unit 162 determines a required output torque based on the actual accelerator pedal press-down degree θacc or throttle opening degree θth from a pre-stored relationship, and determines target engine speed Nem for obtaining engine output torque Te corresponding to the required output torque. It then calculates target slip rotational speed Nsm (=Nem−Nin) for obtaining the determined target engine speed Nem, based on the actual turbine rotational speed Nt, i.e., input shaft rotational speed Nin.

When the vehicle starting state is determined by vehicle start determining unit 164 and in receipt of target slip rotational speed Nsm from target slip value determining unit 162, lock-up clutch control unit 160 determines whether to perform slip control or not, according to whether there is a history that the vehicle ran at a vehicle speed V of not lower than a prescribed threshold value Vth after the timing when the previous slip control was initiated.

More specifically, lock-up clutch control unit 160 outputs to running history storing unit 166 a signal ST indicating the initiation of the slip control at the timing when the slip control was initiated. In receipt of signal ST, running history storing unit 166 stores the change of vehicle speed V over time after the timing when signal ST was input.

When the vehicle starts running from the starting state, if it is not in heavy traffic, vehicle speed V gradually increases with the accelerated state maintained. When it reaches a desired vehicle speed V, throttle opening degree θth as well as engine speed Ne becomes constant, so that the vehicle enters a constant-speed running state with vehicle speed V being approximately constant. Running history storing unit 166 stores such changes of vehicle speed V over time, and when detecting that vehicle speed V has become equal to or greater than prescribed threshold value Vth, it operates to change a running history flag F1 from an off state to an on state. That is, running history flag F1 is set to an on state when it is detected that the running state has continued after the start of the vehicle until vehicle speed V attains prescribed threshold value Vth or greater.

Meanwhile, when the vehicle is in heavy traffic, only after a short period of time following the start, the accelerator pedal would be released and the vehicle would enter an engine brake state, or the brake pedal would be depressed and the vehicle would enter a brake state. That is, when the vehicle is running in heavy traffic, acceleration and deceleration are repeated more often than when the vehicle is running in normal traffic. Thus, vehicle speed V would remain at a low speed, not reaching threshold value Vth. In this case, running history storing unit 166 maintains running history flag F 1 at an off state, since vehicle speed V does not exceed threshold value Vth. Running history storing unit 166 transfers running history flag F1 of an on or off state to lock-up clutch control unit 160.

Lock-up clutch control unit 160 receives target slip rotational speed Nsm from target slip value determining unit 162, and receives running history flag F1 from running history storing unit 166. When running history flag F1 is in an on state, lock-up clutch control unit 160 performs slip control in accordance with target slip rotational speed Nsm. More specifically, lock-up clutch control unit 160 uses a feedback control expression shown by the following expression (6) to control electromagnetic switching valve 50 and linear solenoid valve 54 of hydraulic control circuit 44 (see FIG. 2) to control the engagement torque of lock-up clutch 38 so that the actual slip rotational speed Ns (=Ne−Nin) becomes equal to target slip rotational speed Nsm.
ISLU=(Kp o e+KI o e+KD o de/dt)+KFF (f(Te, θth, Nt)) (6)

In the expression (6), e represents a deviation of the actual slip rotational speed Ns from target slip rotational speed Nsm, Kp is a proportional constant, KI is an integration constant, KD is a differential constant, KFF is a feed forward constant, the first term on the right side is a feedback term, and the second term on the right side is a feed forward term.

Meanwhile, if running history flag F1 is in an off state, lock-up clutch control unit 160 does not perform slip control even if the vehicle is in the starting state.

With the configuration described above, lock-up clutch control unit 160 carries out the slip control only in the case where the vehicle maintains the running state, after it starts moving, until vehicle speed V becomes equal to or greater than a prescribed threshold value Vth. In the case where the vehicle is in heavy traffic, the slip control is not carried out even if the vehicle repeatedly attains the starting state. This can reduce the frequency of execution of the slip control, and thus prevents degradation in durability of lock-up clutch 38.

Running history storing unit 166 resets running history flag F1 from the on state to an off state, once the slip control is initiated, in receipt of signal ST indicating the initiation of the slip control from lock-up clutch control unit 160. It stores the change in vehicle speed V over time after the timing of the initiation of the slip control of this time, and sets running history flag F1 to an on state when it detects that vehicle speed V has become equal to or greater than prescribed threshold value Vth.

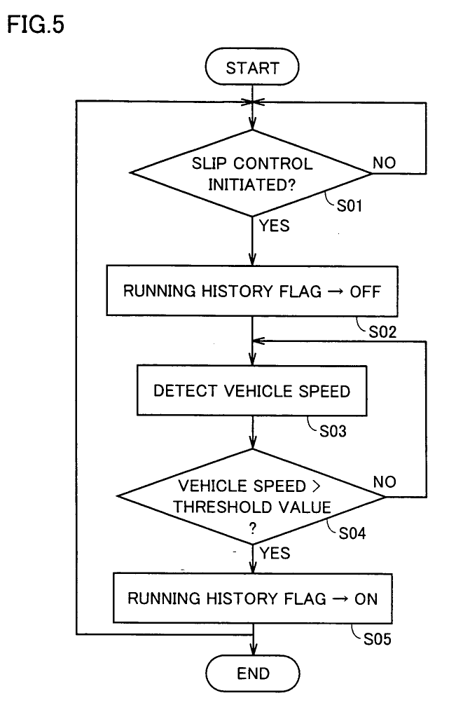

FIG. 5 is a flowchart illustrating a running history storing operation that is executed by running history storing unit 166 shown in FIG. 4.

Initially, lock-up clutch control unit 160 initiates execution of slip control in response to running history flag F1 set to an on state, and outputs signal ST indicating the initiation of execution of the slip control to running history storing unit 166. In receipt of signal ST, running history storing unit 166 determines that the slip control has been initiated (step S01), and resets running history flag F1 from the on state to an off state (step S02).

Further, running history storing unit 166 starts detection of vehicle speed V supplied from a vehicle speed sensor, in response to an input timing of signal ST. Running history storing unit 166 then stores the changes of the detected vehicle speed V over time with the timing of initiation of the slip control as the starting point (step S03). In parallel with this storing operation, running history storing unit 166 performs a determination operation as to whether vehicle speed V changing from time to time has become equal to or greater than a prescribed threshold value Vth (step S04). When it is determined in step S04 that vehicle speed V has become threshold value Vth or greater, it switches running history flag F1 from the off state to an on state (step S05).

Meanwhile, if it is determined in step S04 that vehicle speed V is still lower than threshold value Vth, it continues the operation of detecting vehicle speed V in step S03, while keeping running history flag F1 at the off state.

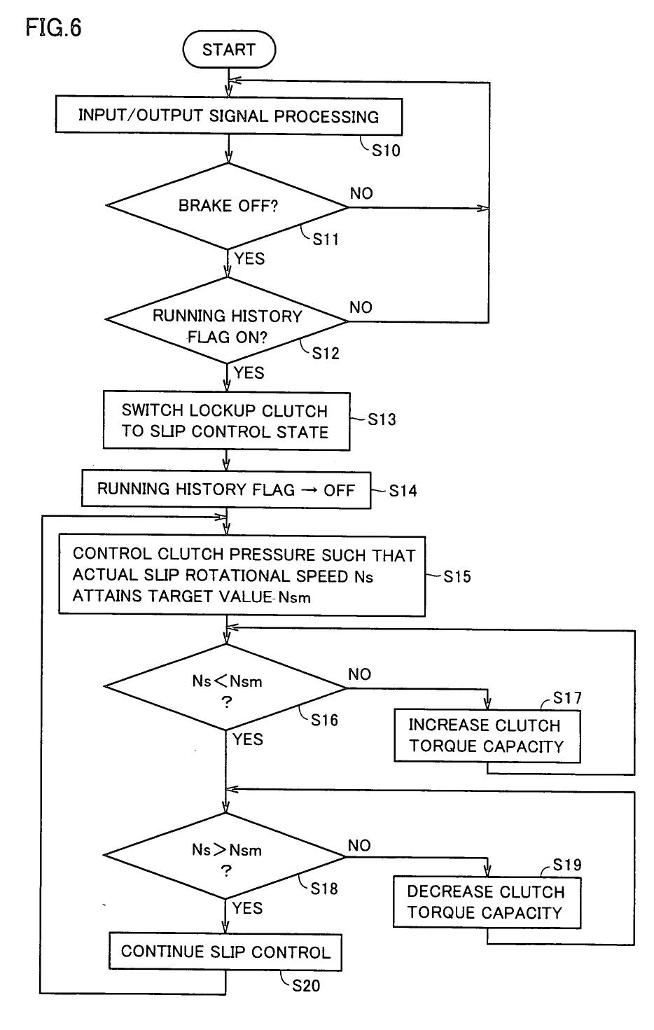

Running history flag F1 having been set to an on or off state through steps S01-S05 above is transferred to lock-up clutch control unit 160. In receipt of running history flag F1, lock-up clutch control unit 160 carries out the slip control of lock-up clutch 38 in accordance with the flowchart shown in FIG. 6.

FIG. 6 is a flowchart illustrating the slip control of lock-up clutch 38 that is executed by lock-up clutch control unit 160 shown in FIG. 4.

Referring to FIG. 6, initially, input/output signal processing as is well known is carried out (step S10), and it is determined whether the vehicle is in a starting state or not according to whether the brake pedal has been returned to a non-operated state (off position) (step S11). This step is carried out by vehicle start determining unit 164 shown in FIG. 4.

If it is determined in step S11 that the brake pedal is in an off state and the vehicle is in a starting state, lock-up clutch control unit 160 determines whether running history flag F1 input from running history storing unit 166 is in an on state or not, to determine whether to perform the slip control based on the determined result (step S12). If it is determined in step S11 that the vehicle is not in the starting state, step S10 is repeatedly performed for standby.

If it is determined in step S12 that running history flag F1 is in an on state, lock-up clutch control unit 160 switches lock-up clutch 38 to a slip control state (step S13). More specifically, lock-up clutch control unit 160 switches clutch switching valve 52 to an on side by means of electromagnetic switching valve 50, and actuates slip control valve 56 by means of linear solenoid valve 54. If it is determined that running history flag F1 is not in the on state (i.e., if it is in the off state), lock-up clutch control unit 160 returns to step S10 again for standby.

In parallel with the switching to the slip control state in step S13, lock-up clutch control unit 160 outputs signal ST indicating the initiation of the slip control to running history storing unit 166. In receipt of signal ST, running history storing unit 166 resets running history flag F1 from the on state to an off state (step S14).

Next, when the slip control is initiated, lock-up clutch control unit 160 controls electromagnetic switching valve 50 and linear solenoid valve 54 of hydraulic control circuit 44 such that the actual slip rotational speed Ns (=Ne−Nin) becomes the target slip rotational speed Nsm, so as to control the engagement torque of lock-up clutch 38 (step S15). At this time, target slip value determining unit 162 determines a required output torque based on the actual accelerator pedal press-down degree θacc or throttle opening degree θth, and determines target engine speed Nem for obtaining engine output torque Te corresponding to the required output torque thus determined. Target slip value determining unit 162 calculates target slip rotational speed Nsm (=Nem−Nin) for obtaining the target engine speed Nem based on the actual turbine rotational speed Nt (i.e., input shaft rotational speed Nin), and outputs it to lock-up clutch control unit 160. This target slip rotational speed Nsm is for causing engine speed Ne at the time of vehicle start to gradually approach the turbine rotational speed Nt (=input shaft rotational speed Nin) that increases with vehicle speed V.

Next, lock-up clutch control unit 160 determines whether the actual slip rotational speed Ns (=Ne−Nin) is smaller than target slip rotational speed Nsm (step S16). If slip rotational speed Ns is equal to or greater than target slip rotational speed Nsm, the torque capacity (transmission torque) of lock-up clutch 38 is increased by a prescribed value so as to decrease slip rotational speed Ns (step S17). The determination in step S16 is then made again.

If it is determined in step S16 that slip rotational speed Ns is smaller than target slip rotational speed Nsm, determination is then made as to whether slip rotational speed Ns is greater than target slip rotational speed Nsm (step S18). If slip rotational speed Ns is not greater than target slip rotational speed Nsm, the torque capacity of lock-up clutch 38 is decreased by a prescribed value so as to increase slip rotational speed Ns (step S19). The determination in step S18 is then made again.

If it is determined in step S18 that slip rotational speed Ns is greater than target slip rotational speed Nsm, i.e., if it is determined that the actual slip rotational speed Ns is approximately equal to target slip rotational speed Nsm, then the slip control state is maintained without modification (step S20).

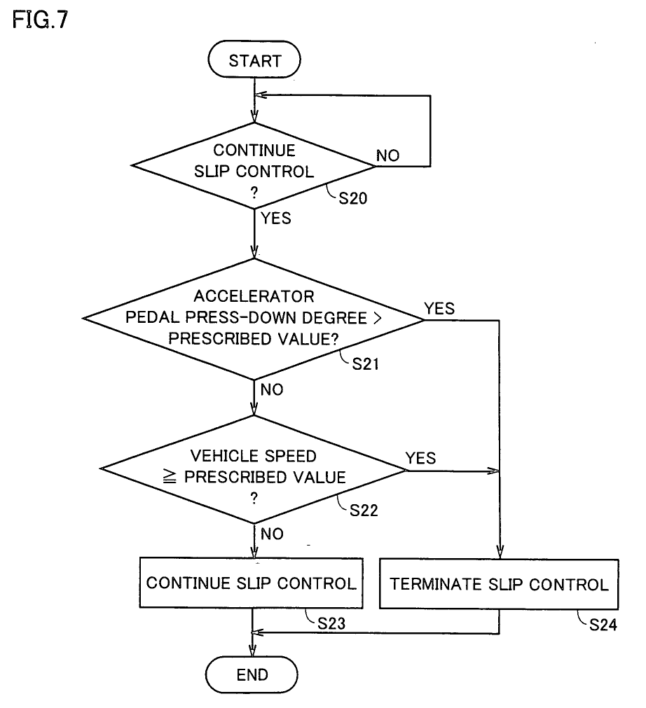

It is noted that the slip control state is maintained with the fulfillment of a prescribed vehicle running state shown in FIG. 7 being the condition for terminating the slip control. FIG. 7 is a flowchart illustrating a slip control termination operation of lock-up clutch 38 that is performed by lock-up clutch control unit 160 shown in FIG. 4.

Referring to FIG. 7, lock-up clutch control unit 160, while continuing the slip control (step S20), determines whether the prescribed vehicle running states shown in steps S21 and S22 are satisfied or not, and if so, it terminates the slip control (step S24). If it is determined that the prescribed vehicle running states are not satisfied, the slip control is continued (step S23).

As one prescribed vehicle running state, lock-up clutch control unit 160 determines whether accelerator pedal press-down degree θacc (or throttle opening degree θth) exceeds a prescribed value or not (step S21). If it is determined that accelerator pedal press-down degree θacc exceeds the prescribed value, i.e., if it is determined that the vehicle is in a prescribed acceleration state, lock-up clutch control unit 160 terminates the slip control of lock-up clutch 38 (step S24), and sets lock-up clutch 38 to a released state.

If it is determined in step S21 that accelerator pedal press-down degree θacc is not greater than the prescribed value, lock-up clutch control unit 160 then determines whether vehicle speed V has increased to exceed a prescribed value (step S22). If so, lock-up clutch control unit 160 terminates the slip control of lock-up clutch 38 (step S24), and sets lock-up clutch 38 to a completely engaged state.

In this manner, the slip control of lock-up clutch 38 is terminated when a prescribed vehicle running state is satisfied at the start of the vehicle. Thus, it is possible to obtain favorable anti-engine stall characteristic as well as improved starting and accelerating capabilities of the vehicle.

In the present invention, the running history storing unit may be configured, not only to store the above-described changes of vehicle speed V over time, but also to recognize and store the vehicle running state in heavy traffic, based on the running history information and the heavy traffic information obtained from a car navigation system mounted to the vehicle or the like.

As described above, according to the embodiment of the present invention, when it is determined that the vehicle is running in heavy traffic based on the set state of the running history flag, the slip control at the time of start of the vehicle is not performed, which suppresses an increase in frequency of execution of the slip control of the lock-up clutch. As a result, durability of the friction member of the lock-up clutch can be guaranteed, without impairing favorable fuel economy upon start of the vehicle.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A control apparatus of a lock-up clutch for a vehicle having a hydraulic power transmitting device equipped with a lock-up clutch, comprising:
a slip control unit for executing slip control of said lock-up clutch upon a start of said vehicle; and
a running history storing unit storing a running history of said vehicle in response to execution of said slip control after the timing of initiation of said slip control;
said slip control unit executing or prohibiting said slip control upon the start of said vehicle based on the running history of said vehicle stored.

2. The control apparatus of a lock-up clutch for a vehicle according to claim 1, wherein said slip control unit prohibits said slip control when it is determined from the running history of said vehicle that said vehicle is running in heavy traffic.

3. The control apparatus of a lock-up clutch for a vehicle according to claim 2, wherein
said running history storing unit stores a change of a vehicle speed over time after the timing of initiation of said slip control, and
said slip control unit determines, upon the start of said vehicle, that said vehicle is running in heavy traffic based on the absence of a history indicating that said vehicle ran at a vehicle speed of not lower than a prescribed threshold value after the timing of initiation of said slip control in a previous time.

4. The control apparatus of a lock-up clutch for a vehicle according to claim 3, wherein said prescribed threshold value is set to exceed said vehicle speed at the time when said vehicle is running in heavy traffic.

5. The control apparatus of a lock-up clutch for a vehicle according to claim 3, wherein
said running history storing unit has a flag that is set to a first state in response to the initiation of said slip control, and changed from the first state to a second state in response to said vehicle speed exceeding said prescribed threshold value after the timing of the initiation of said slip control, and
said slip control unit executes said slip control in response to said flag being set at said second state, and prohibits said slip control in response to said flag being set at said first state, upon the start of said vehicle.

6. A control apparatus of a lock-up clutch for a vehicle having a hydraulic power transmitting device equipped with a lock-up clutch, comprising:
slip control means for executing slip control of said lock-up clutch upon a start of said vehicle; and
running history storing means for storing a running history of said vehicle in response to execution of said slip control after the timing of initiation of said slip control;
said slip control means including means for executing or prohibiting said slip control upon the start of said vehicle based on the running history of said vehicle stored.

7. The control apparatus of a lock-up clutch for a vehicle according to claim 6, wherein said slip control means includes means for prohibiting said slip control when it is determined from the running history of said vehicle that said vehicle is running in heavy traffic.

8. The control apparatus of a lock-up clutch for a vehicle according to claim 7, wherein
said running history storing means includes means for storing a change of a vehicle speed over time after the timing of initiation of said slip control, and
said slip control means includes means for determining, upon the start of said vehicle, that said vehicle is running in heavy traffic based on the absence of a history indicating that said vehicle ran at a vehicle speed of not lower than a prescribed threshold value after the timing of initiation of said slip control in a previous time.

9. The control apparatus of a lock-up clutch for a vehicle according to claim 8, wherein said prescribed threshold value is set to exceed said vehicle speed at the time when said vehicle is running in heavy traffic.

10. The control apparatus of a lock-up clutch for a vehicle according to claim 8, wherein
said running history storing means has a flag that is set to a first state in response to the initiation of said slip control, and changed from the first state to a second state in response to said vehicle speed exceeding said prescribed threshold value after the timing of the initiation of said slip control, and
said slip control means includes means for executing said slip control in response to said flag being set at said second state, and prohibiting said slip control in response to said flag being set at said first state, upon the start of said vehicle.
